(19) United States
(12) Patent Application Publication
(10) Pub. No.: US 2009/0015706 A1
(43) Pub. Date: Jan. 15, 2009

(54) Auto focus/zoom modules using wafer level optics

(76) Inventor: Harpuneet Singh, Dublin, CA (US)

Correspondence Address: HENNEMAN & ASSOCIATES, PLC, 714 W. MICHIGAN AVENUE, THREE RIVERS, MI, 49093, US

(21) Appl. No.: 12/150,119

(22) Filed: Apr. 24, 2008

Related U.S. Application Data
(60) Provisional application No. 60/925,947, filed on Apr. 24, 2007.

(51) Int. Cl. H04N 5/225

(52) U.S. Cl. 348/340; 348/E05.024

(57) ABSTRACT

A disclosed example camera module includes a substrate, an integrated circuit image capture device (ICD) mounted on the substrate, the image capture device having an array of light sensors on its top surface, a first lens unit rigidly fixed to the top surface of the image capture device, a second lens unit, and a lens actuator mounted on the substrate. The lens actuator adjustably supports the second lens unit over the first lens unit. The first lens unit includes a stacked plurality of lenses. Optionally, the second lens unit also includes a stacked plurality of lenses. Movement of the second lens unit with respect to the first lens unit provides a focus and/or zoom function.

### RELATED APPLICATIONS

This application claims the benefit of copending U.S. Provisional Patent Application No. 60/925,947, filed Apr. 24, 2007 by the same inventor, which is incorporated herein by reference in its entirety.

### BACKGROUND OF THE INVENTION

1. Field of the Invention

This invention relates generally to electronic devices, and more particularly to digital camera modules. Even more particularly, this invention relates to camera modules incorporating variable focus/zoom devices.

2. Description of the Background Art

Digital camera modules are currently being incorporated into a variety of host devices. Such host devices include cellular telephones, personal data assistants (PDAs), computers, and so on. Therefore, consumer demand for digital camera modules in host devices continues to grow.

Host device manufacturers prefer digital camera modules to be small, so that they can be incorporated into the host device without increasing the overall size of the host device. Further, host device manufacturers prefer camera modules that minimally affect host device design. In meeting these requirements the host device manufacturers prefer camera modules that capture images of the highest possible quality. Of course, it is an ongoing goal for camera module manufacturers to design camera modules that meet these requirements at minimal manufacturing cost.

A conventional digital camera module generally includes a lens assembly, a housing, a printed circuit board (PCB), and an integrated image capture device (ICD). Typically, the components are formed separately and later assembled to create the digital camera module. That is, the ICD is attached to the PCB, and then the housing is attached to the PCB so that the ICD is covered by the bottom of the housing. Then, the lens assembly is mounted to the opposite end of the housing to focus incident light onto an image capture surface of the ICD. The ICD is electrically coupled to the PCB, which includes a plurality of electrical contacts for the ICD to communicate image data to the host device for processing, display, and storage.

It is also common for digital cameras, although not necessarily miniature camera modules, to include a variable focus/zoom device for enhancing the quality of images captured at various focal fields. Typically, the variable focus/zoom device includes an electronic actuator coupled to one or more lenses of the lens assembly for changing the displacement of the lens(s) with respect to the image capture surface of the ICD and with respect to each other.

In manufacturing miniature camera modules, many problems are encountered by the camera module manufacturers. As one example, bare ICD dies are extremely vulnerable to contamination before and during assembly. When the image capture surface is exposed to dust and/or other particulate debris, these contaminants can block incident light, resulting in visible defects in the images captured. Such contamination often results in the discarding of the defective image capture devices, which can be extremely expensive, especially when yield losses are high. In efforts to minimize contamination, the camera modules have to be carefully assembled in a class 100 clean room. Although the image capture devices of assembled camera modules are protected against contaminants from outside of the camera module, they are still vulnerable to internally generated contaminants. Such internal contaminants are usually the result of dust, component adhesives (e.g., epoxy), and/or particulates formed by frictional wear within the camera module. Frictional wear is typical when components are assembled or after the assembly, such as when movable components (e.g., variable zoom/focus devices) within the camera modules are actuated. Contamination of an image sensor after the camera is assembled can be especially expensive because the entire camera module may have to be discarded.

Another problem is that variable focus/zoom devices typically include multiple moving optical elements, which have to be extremely small to be incorporated into miniature camera modules and, therefore, require extremely delicate processes for fabrication, assembly, and alignment. Indeed, the alignment process becomes increasingly more difficult as the number of required camera module components is increased. This is because the lenses have to be positioned with respect to the ICD within a predetermined tolerance. The overall tolerance is an accumulation of other intermediate component tolerances. Ideally, the lenses should all be coaxially perpendicular to the center of the planar image capture surface. However, this is typically only achieved within a predetermined overall tolerance defined by the sum of: the tolerance of the ICD with respect to the PCB, the tolerance of the PCB with respect to the housing, the tolerance of the housing with respect to the focus/zoom device, and the tolerances of the lenses with respect to the focus/zoom device.

One prior art method for minimizing the contamination of the ICD during the assembly of the camera module includes fixing a transparent protective substrate (e.g., a glass plate) over the image capture surfaces. Typically, this is achieved by adhering the transparent substrate directly over the image capture surface via a transparent adhesive. Another common method includes forming an annular element around the peripheral surface of the image capture device, then adhering the transparent substrate to the annular element so as to form a space between the image capture surface and the transparent substrate.

Although a transparent cover may protect the image capture surface from some contaminants before the camera module is assembled, the camera module is still extremely vulnerable to contamination and the resulting image quality degradation. For example, contaminants can still collect on the transparent substrate which itself is vulnerable to contamination. As another example, the process of applying the transparent cover to the ICD could itself cause contamination. Further, the additional components are likely to increase the overall costs of the manufacturing the camera modules and increase the manufacturing time.

What is needed, therefore, is a camera module that is less vulnerable to contamination. What is also need is a camera module that can be assembled with a more forgiving tolerances. What is also needed is a camera module that requires fewer components and fewer manufacturing steps. What is also needed is a method of assembling a miniature camera module with an autofocus and/or zoom feature.

### SUMMARY

The present invention overcomes the problems associated with the prior art by providing a camera module with an autofocus and/or zoom feature that is less vulnerable to contamination, requires fewer components and manufacturing steps, and can be assembled with more forgiving manufacturing tolerances. A disclosed example camera module includes a substrate, an integrated circuit image capture device (ICD) mounted on the substrate, the image capture device having an array of light sensors on its top surface, a first lens unit rigidly fixed to the top surface of the image capture device, a second lens unit, and a lens actuator mounted on the substrate. The lens actuator adjustably supports the second lens unit over the first lens unit. The first lens unit includes a stacked plurality of lenses. Optionally, the second lens unit also includes a stacked plurality of lenses. Movement of the second lens unit with respect to the first lens unit provides a focus and/or zoom function.

In the disclosed example embodiment, the first lens unit includes a first lens element having a bottom surface and a second lens element having a top surface and a bottom surface. The top surface of the second lens element is adhered to the bottom surface of the first lens element, and the bottom surface of the second lens element is adhered to said top surface of said image capture device.

The first lens unit is adhered to the top surface of the image capture device such that the array of light sensors is sealed between the image capture device and the first lens unit. The first lens unit includes a mounting surface having a cavity formed therein, and the mounting surface is fixed to the top surface of the image capture device at an area surrounding the sensor array such that the cavity is disposed over the sensor array. In a particular embodiment, a top surface of the first lens unit is at least 1-2 mm from the top surface of the image capture device.

A method of manufacturing camera modules is also disclosed. The example method disclosed includes providing an integrated circuit ICD including a sensor array on its top surface, providing a first lens unit, rigidly attaching the first lens unit to the top surface of the ICD, mounting the image capture device on a substrate, providing an electromechanical actuator assembly having a second lens unit adjustably mounted therein, and mounting the electro-mechanical actuator assembly on the substrate with the second lens unit disposed a spaced distance above the first lens unit. In a particular method, the step of providing the first lens unit includes providing a first lens substrate having a plurality of individual lenses formed therein, providing a second lens substrate having a plurality of individual lenses formed therein, adhering at least a portion of a bottom surface of the first lens substrate to at least a portion of a top surface of the second lens substrate. The step of rigidly attaching the first lens unit to the top surface of the image capture device includes providing an integrated circuit substrate including the image capture device and a plurality of other image capture devices, providing a lens substrate having a plurality of individual lenses formed therein, at least one of the lenses forming a portion of the first lens unit and others of the lenses forming portions of other lens units, and adhering at least a portion of a bottom surface of the lens substrate to the top surface of the image capture device, thereby attaching said first lens unit to said image capture device and attaching said other lens units to said other image capture devices. The method further includes dividing the lens substrate and the integrated circuit substrate to produce a plurality of separate image capture devices, each having one of the lens units attached thereto.

In an alternative method, the step of providing an integrated circuit ICD includes providing an integrated circuit ICD having a transparent cover (e.g., a glass plate) over the top surface. The step of rigidly attaching a first lens unit to the top surface of the image capture device includes fixing the first lens unit to the transparent cover.

In the example method, the first lens unit includes a stacked plurality of lens elements. Optionally, at least one element of the stacked plurality of lens elements includes an infrared filter integrated therein.

As another option, the method further includes programming the image capture device with data indicative of at least one optical characteristic of the first lens unit.

A disclosed example camera module can also be described as including a substrate, an integrated circuit ICD mounted on said substrate, the ICD having an array of light sensors on its top surface, a first lens unit, means for mounting the first lens unit with respect to the image capture device, a second lens unit, and a lens actuator mounted on the substrate, the actuator adjustably positioning the second lens unit with respect to the first lens unit.

### BRIEF DESCRIPTION OF THE DRAWINGS

The present invention is described with reference to the following drawings, wherein like reference numbers denote substantially similar elements:

FIG. 1 is a perspective view of a camera module of the present invention mounted on a printed circuit board (PCB) of a host device;

FIG. 2 is a partially sectioned, perspective view of the camera module of FIG. 1;

FIG. 3 is a partially sectioned, perspective view of internal components of the camera module of FIG. 1;

FIG. 4 is an exploded perspective view of a plurality of glass wafers used to manufacture optical component stacks of the camera module shown in FIG. 2;

FIG. 5 is a cross sectional view of a portion of the glass wafers of FIG. 4 after an alignment and bonding process; and

FIG. 6 is a flow chart summarizing one particular method of manufacturing camera modules according to the present invention.

### DETAILED DESCRIPTION

The present invention overcomes the problems associated with the prior art, by providing a novel method of manufacturing a miniature camera module with an autofocus and/or zoom feature. In the following description, numerous specific details are set forth (e.g., number of lens elements in an optical stack, etc.) in order to provide a thorough understanding of the invention. Those skilled in the art will recognize, however, that the invention may be practiced apart from these specific details. In other instances, details of well known electronic assembly practices and components have been omitted, so as not to unnecessarily obscure the present invention.

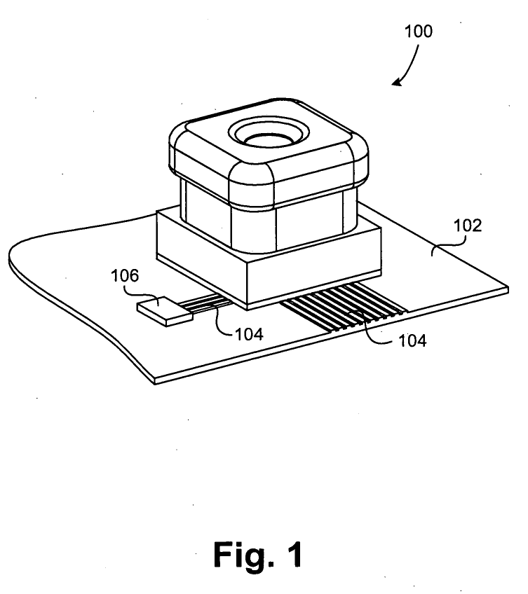

FIG. 1 is a perspective view of a camera module 100 according to one embodiment of the present invention. Camera module 100 is shown mounted on a portion of a printed circuit board (PCB) 102 that represents a PCB of a camera hosting device. Camera module 100 communicates electronically with other components of the hosting device via a plurality of conductive traces 104. Device 106 represents an electronic component (e.g., passive component) that may be mounted directly on PCB 102. Those skilled in the art will recognize that the particular design of PCB 102 will depend on the particular application, and is not particularly relevant to the present invention. Therefore, PCB 102, traces 104, and device 106 are representational in character only.

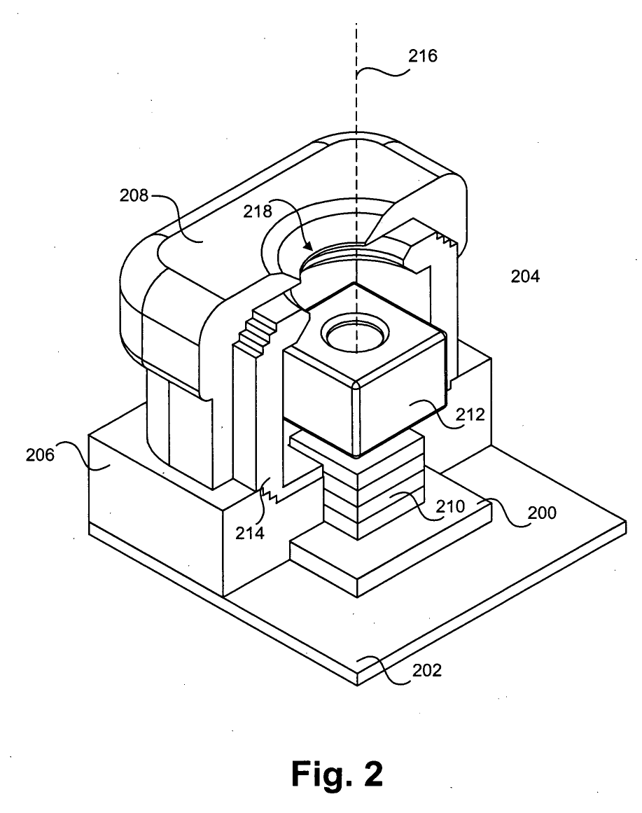

FIG. 2 is a partially sectioned, perspective view of camera module 100 including an integrated circuit image capture device (ICD) 200, PCB 202, focus/zoom device 204, base 206, and a housing 208. ICD 202 is mounted and electrically coupled to PCB 202 by means commonly known to those in the art (e.g., wire bonding, reflow soldering, etc.). Focus/zoom device 204 includes an optical stack 210, lens carrier 212, and an actuator 214. Optical stack 210 and lens carrier 212 are coaxially positioned along an optical axis 216 which is perpendicular to and centered with respect to an image capture surface of ICD 200. Optical stack 210 is rigidly fixed onto the top surface of ICD 200, while lens carrier 212 is movable along axis 216. Actuator 214 is an electromechanical device (e.g., MEMS, piezoelectric, voice coil, etc.) that is operative to position lens carrier 212 with respect to optical stack 210 responsive to an electronic control signal. In particular, when actuator 214 receives a signal indicative of a particular focal/zoom field, actuator 214 positions lens carrier 212 a corresponding distance from optical stack 210.

Base 206 is a rigid substrate formed directly over PCB 202 and the peripheral edges of ICD 202, so as to provide support to actuator 214 and housing 208. Base 206 can be formed by any of several means. For example, base 206 can be preformed then attached to PCB 202. Alternatively, base 206 can be molded directly onto PCB 202 after ICD 200 and optical stack 210 are fixed to PCB 202. As yet another alternative, base 206 and actuator 214 can be integrated as a single component. As yet even another alternative, ICD 200 (with optical stack 210 attached) can be flip-chip mounted to base 206, which can then be mounted to PCB 202 by, for example, a reflow soldering process.

Housing 208 is formed directly over base 206 and actuator 214 so as to provide protection to the internal components of camera module 100. Housing 208 includes an aperture 218, which allows light to enter camera module 100. Aperture 218 can be covered by a transparent material (e.g., lens, IR filter, etc.) to further prevent external debris from entering camera module 100. The formation of housing 208 can be achieved by any of several means. For example, housing 208 can be prefabricated then attached to base 206 and actuator 214. As another example, housing 208 can be overmolded onto base 206 and actuator 214. It should be noted that the alignment of optical stack 210 and lens carrier 212 with respect to ICD 202 does not depend on the alignment of housing 208 with respect to ICD 200 because housing 208 is not an intermediate component. Therefore, housing 208 does not contribute to problems associated with lens alignment tolerance accumulation.

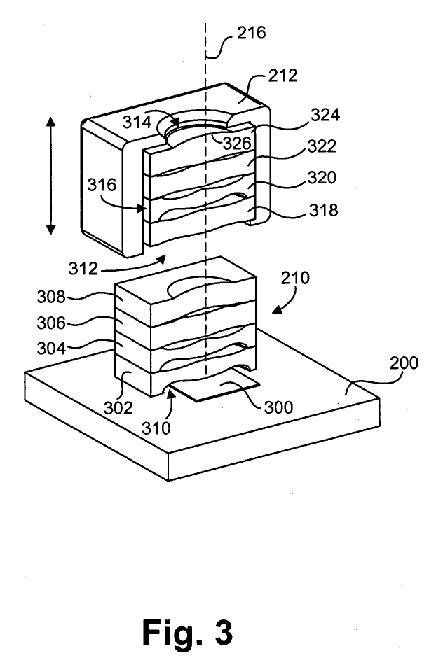

FIG. 3 is a partially sectioned perspective view of ICD 200, optical stack 210, and lens carrier 212. ICD 200 includes a planar image capture surface 300 which is perpendicular to optical axis 216. As can be seen, optical axis 216 passes through the center of optical stack 210, lens carrier 212, and image capture surface 300.

Optical stack 210 includes a stack of four lenses 302, 304, 306, and 308 fixed to one another and mounted over image capture surface 300. In particular, the bottom surface of lens 302 is directly fixed to ICD 200, lens 304 is fixed to lens 302, lens 306 is fixed to lens 304, and lens 308 is fixed to lens 306. Further, the bottom surface of lens 302 defines an opening into a cavity 310, the opening having an area slightly greater than the area of image capture surface 300 so as to prevent contact between lens 302 and image capture surface 300. It is important to recognize that after optical stack 210 is fixed to ICD 200, contamination or image degradation due to post assembly processes is very unlikely. This is because debris collecting on the top surface of lens 308 is too far away from the image focal plane to cause blemish related yield loss. In addition, the bonding of lens 302 to ICD 200 effectively seals image capture surface 300 within cavity 310, thereby preventing contaminants from reaching image capture surface 300.

Lens carrier 212 defines a cavity 312 and an optical aperture 314. Cavity 312 fixably seats a second optical stack 316, which includes a stack of four lenses 318, 320, 322, and 324 fixed to one another. In particular, lens 320 is fixed to lens 318, lens 322 is fixed to lens 320, and lens 324 is fixed to lens 322. Lens 324 defines a convex surface 326 which is seated within aperture 314. Although not shown, lens carrier 212 includes a feature (e.g., ferrous element, magnet, guide rails, rigid lip, etc.) which reacts to an electrical or mechanical force (e.g., magnetic force, piezoelectric biasing force, etc.) provided by actuator 214 for moving lens carrier 212 with respect to optical stack 210. In response to an actuating force, lens carrier 212 and optical stack 316 are displaced with respect to image capture surface 300 along axis 216, thereby changing the focal/zoom field.

In addition, ICD 200 includes data indicative of the optical characteristics of at least one of optical stack 210 and optical stack 316. Providing this information in the programming code of ICD 200 facilitates the use of software such as enhanced depth of field (EDOF) and optical fault correction (OFC). Optical features created in the wafer level optics can then be used by the software for image enhancement. This feature can also improve module yield by correcting image artifacts.

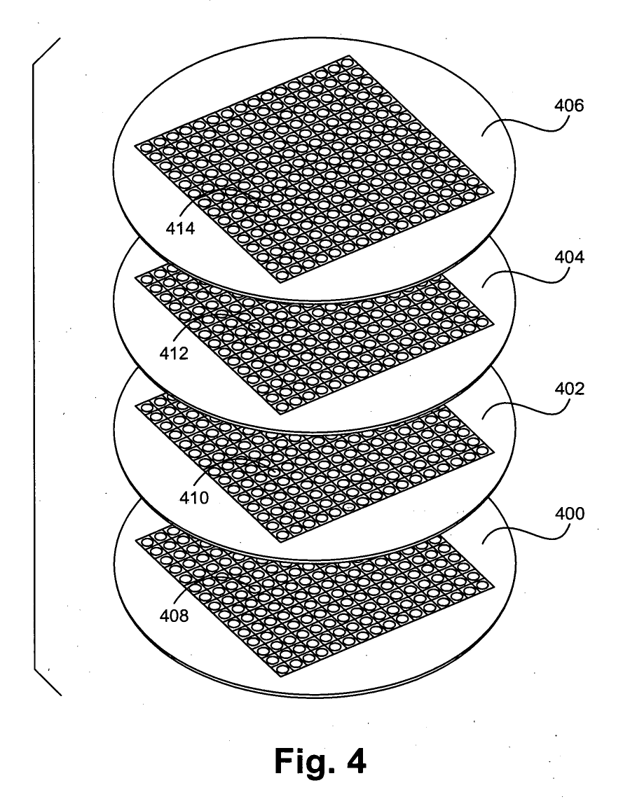

FIG. 4 is an exploded perspective view of four glass wafers 400, 402, 404, and 406 used in forming optical stack 210. Glass wafers 400, 402, 404, and, 406 include lens arrays 408, 410, 412, and 414, respectively, which are individually formed by some suitable means such as etching/replication technology. After the lens arrays are formed, the glass wafers are vertically aligned such that each individual lens is coaxially aligned with three other individual lenses. The glass wafers are then adhered to one another in a stacked relationship in preparation for a separation process which will yield several individual optical stacks 210.

Alternatively, glass wafers 400, 402, 404, and 406 can be bonded to a wafer including a like plurality of integrated circuit image capture devices, before separation of the wafers into individual ICDs with attached lens stacks. However, it can be more difficult to separate the lens wafers and the ICD wafer at the same time, because separation may require the dicing of the glass wafers over the active areas of the silicon ICD wafer. In addition, bonding the lenses to the wafers prior to separation reduces the yield of lenses from the glass wafers, because the lens stacks occupy a smaller area than the ICDs. Therefore, if the glass wafers are diced prior to attachment to the ICD wafer, the lenses can be positioned closer together rather than having a spacing that must match the spacing of the ICDs.

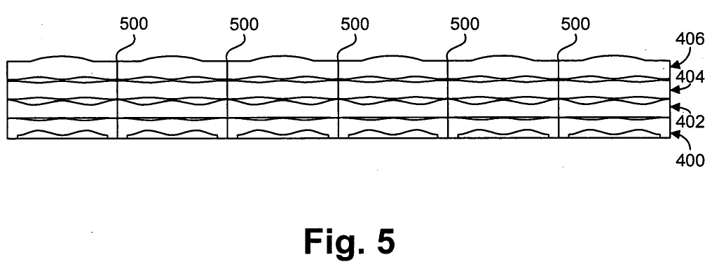

FIG. 5 is a cross-sectional view of a small portion of glass wafers 400, 402, 404, and 406 aligned and adhered to one another. After the glass wafers are adhered to one and other, the lenses are tested for quality and then diced along lines 500 forming multiple individual optical stacks 210. After individual optical stacks 210 are formed, they are cleaned and prepared to be mounted on ICDs. Note that optical stack 316 is formed using the same general process used to form optical stack 210, but of course with differently shaped lens elements.

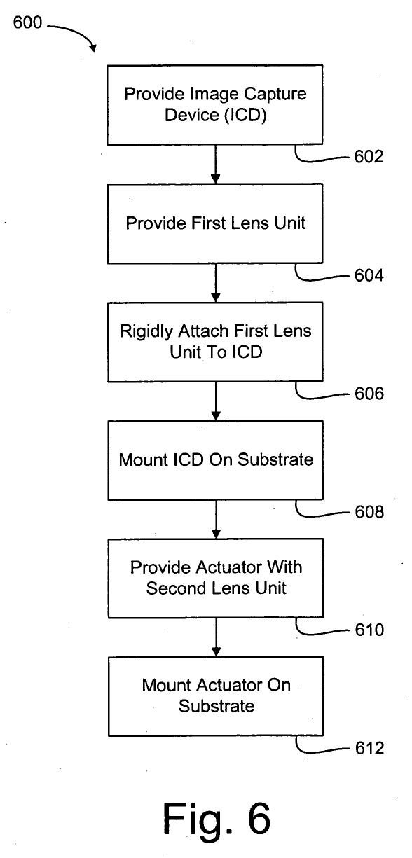

FIG. 6 is a flowchart summarizing one method 600 of manufacturing an autofocus/zoom camera module according to the present invention. In a first step 602, an image capture device (ICD) is provided. Then, in a second step 604, a first lens unit is provided. Next, in a third step 606, the first lens unit is rigidly attached to the ICD. Optionally, steps 602, 604, and 606 occur at the wafer level. That is, these steps occur while the ICD is still incorporated in a wafer with other ICDs, and while the lens elements are still incorporated in glass wafers with other lens elements.

Next, in a fourth step 608, the ICD (with first lens unit attached) is mounted on a substrate (e.g., a PCB of a host device). Then, in a fifth step 610 an actuator with a second lens unit is provided, and in a sixth step 612, the actuator is mounted on the substrate over the ICD and the first lens unit.

The description of particular embodiments of the present invention is now complete. Many of the described features may be substituted, altered or omitted without departing from the scope of the invention. For example, alternate lens units may be substituted for the optical stacks shown. As another example, different electronic mounting processes can be used to assemble the camera modules. These and other deviations from the particular embodiments shown will be apparent to those skilled in the art, particularly in view of the foregoing disclosure.

I claim:

1. A camera module comprising:
a substrate;
an integrated circuit image capture device mounted on said substrate, said image capture device having an array of light sensors on a top surface of said image capture device;
a first lens unit rigidly fixed to said top surface of said image capture device;
a second lens unit; and
a lens actuator mounted on said substrate, said lens actuator adjustably supporting said second lens unit over said first lens unit.

2. The camera module of claim 1, wherein said first lens unit includes a stacked plurality of lenses.

3. The camera module of claim 2, wherein said second lens unit includes a stacked plurality of lenses.

4. The camera module of claim 1, wherein said first lens unit includes:
a first lens element having a bottom surface; and
a second lens element having a top surface and a bottom surface, said top surface of said second lens element being adhered to the bottom surface of said first lens element and said bottom surface of said second lens element being adhered to said top surface of said image capture device.

5. The camera module of claim 1, movement of said second lens unit with respect to said first lens unit provides a focus function.

6. The camera module of claim 1, movement of said second lens unit with respect to said first lens unit provides a zoom function.

7. The camera module of claim 6, movement of said second lens unit with respect to said first lens unit provides a focus function.

8. The camera module of claim 1, wherein said first lens unit is adhered to said top surface of said image capture device such that said array of light sensors is sealed between said image capture device and said first lens unit.

9. The camera module of claim 8, wherein;
a bottom surface of said first lens unit is adhered to said top surface of said image capture device; and
a top surface of said first lens unit is at least 1 mm from said top surface of said image capture device.

10. The camera module of claim 9, wherein said top surface of said first lens unit is at least 2 mm from said top surface of said image capture device.

11. The camera module of claim 1, wherein:
said first lens unit includes a mounting surface having a cavity formed therein; and
said mounting surface is fixed to said top surface of said image capture device at an area surrounding said sensor array such that said cavity is disposed over said sensor array.

12. A method of manufacturing camera modules, said method comprising:
providing an integrated circuit image capture device including a sensor array on a top surface of said image capture device;
providing a first lens unit;
rigidly attaching said first lens unit to said top surface of said image capture device;
mounting said image capture device on a substrate;
providing an electromechanical actuator assembly having a second lens unit adjustably mounted therein; and
mounting said electromechanical actuator assembly on said substrate with said second lens unit disposed a spaced distance above said first lens unit.

13. The method of claim 12, wherein said step of providing said first lens unit includes:
providing a first lens substrate having a plurality of individual lenses formed therein;
providing a second lens substrate having a plurality of individual lenses formed therein;
adhering at least a portion of a bottom surface of said first lens substrate to at least a portion of a top surface of said second lens substrate.

14. The method of claim 12, wherein said step of rigidly attaching said first lens unit to said top surface of said image capture device includes:
providing an integrated circuit substrate including said image capture device and a plurality of other image capture devices;
providing a lens substrate having a plurality of individual lenses formed therein, at least one of said lenses forming a portion of said first lens unit and others of said lenses forming portions of other lens units; and
adhering at least a portion of a bottom surface of said lens substrate to said top surface of said image capture device, thereby attaching said first lens unit to said image capture device and attaching said other lens units to said other image capture devices.

15. The method of claim 14, further comprising dividing said lens substrate and said integrated circuit substrate to produce a plurality of separate image capture devices, each having one of said lens units attached thereto.

16. The method of claim 12, wherein:
said step of providing an integrated circuit image capture device includes providing an integrated circuit image capture device having a transparent cover over said top surface; and
said step of rigidly attaching a first lens unit to said top surface of said image capture device includes fixing said first lens unit to said transparent cover.

17. The method of claim 12, wherein said first lens unit includes a stacked plurality of lens elements.

18. The method of claim 17, wherein at least one element of said stacked plurality of lens elements includes an infrared filter integrated therein.

19. The method of claim 12, further comprising programming said image capture device with data indicative of at least one optical characteristic of said first lens unit.

20. A camera module comprising:
a substrate;
an integrated circuit image capture device mounted on said substrate, said image capture device having an array of light sensors on a top surface of said image capture device;
a first lens unit;
means for mounting said first lens unit with respect to said image capture device;
a second lens unit; and
a lens actuator mounted on said substrate, said actuator adjustably positioning said second lens unit with respect to said first lens unit.
